(19) United States
(12) Patent Application Publication
(10) Pub. No.: US 2025/0056416 A1
(43) Pub. Date: Feb. 13, 2025

(54) DATA TRANSMISSION METHODS, FIRST DEVICE AND SECOND DEVICE

(71) Applicant: GUANGDONG OPPO MOBILE TELECOMMUNICATIONS CORP., LTD., Dongguan (CN)

(72) Inventors: Zhisong ZUO, Dongguan (CN); Shengjiang CUI, Dongguan (CN)

(21) Appl. No.: 18/828,996

(22) Filed: Sep. 9, 2024

Related U.S. Application Data
(63) Continuation of application No. PCT/CN2022/081550, filed on Mar. 17, 2022.

(51) Int. Cl. H04W 52/14; H04L 5/00

(52) U.S. Cl. CPC H04W 52/14; H04L 5/0055

(57) ABSTRACT

A data transmission method, which includes: receiving, by a first device, a downlink signal transmitted by a second device, the downlink signal carrying a terminal identifier; identifying, by the first device, that the terminal identifier is a self identifier of the first device; and transmitting, by the first device, an uplink signal to the second device according to the downlink signal; where the first device is a zero power consumption device.

### CROSS-REFERENCE TO RELATED APPLICATION

This application is a Continuation Application of International Application No. PCT/CN2022/081550 filed on Mar. 17, 2022, which is incorporated herein by reference in its entirety.

### TECHNICAL FIELD

The present disclosure relates to the field of communications, and more particularly, to a data transmission method, a first device and a second device.

### BACKGROUND

A radio frequency identification (RFID) technology, commonly known as an electronic tag, can automatically identify a target object through a radio frequency signal, to realize data transmission. Considering that most of data transmission based on the RFID technology is data transmission between multiple devices. There are multiple devices, therefore, it is necessary to distinguish different devices to ensure correct transmission of data and meet data transmission requirements of zero power consumption between the multiple devices.

### SUMMARY

Embodiments of the present disclosure provide a data transmission method, a first device and a second device.

The embodiments of the present disclosure provide a data transmission method, which is applied to a first device and includes:
receiving, by the first device, a downlink signal transmitted by a second device, the downlink signal carrying a terminal identifier; and
identifying, by the first device, that the terminal identifier is a self identifier of the first device, and transmitting, by the first device, an uplink signal to the second device according to the downlink signal;
where the first device is a zero power consumption device.

The embodiments of the present disclosure provide a data transmission method, which is applied to a second device and includes:
transmitting, by the second device, a downlink signal to a first device, the downlink signal carrying a terminal identifier; and
receiving, by the second device, an uplink signal;
where the uplink signal is a signal obtained according to the downlink signal in a case where the first device performs identification based on the terminal identifier, and the first device is a zero power consumption device.

The embodiments of the present disclosure provide a first device, which includes:
a first receiving unit, configured to receive a downlink signal transmitted by a second device, the downlink signal carrying a terminal identifier; and
a first identification unit, configured to identify that the terminal identifier is a self identifier of the first device, and transmit an uplink signal to the second device according to the downlink signal;
where the first device is a zero power consumption device.

The embodiments of the present disclosure provide a second device, which includes:
a first transmitting unit, configured to transmit a downlink signal to a first device, the downlink signal carrying a terminal identifier; and
a second receiving unit, configured to receive an uplink signal;
where the uplink signal is a signal obtained according to the downlink signal in a case where the first device performs identification based on the terminal identifier, and the first device is a zero power consumption device.

The embodiments of the present disclosure provide a first device, which includes a processor and a memory. The memory is configured to store a computer program, and the processer is configured to call and run the computer program stored in the memory, to cause the terminal device to perform the above method mentioned in the embodiments of the present disclosure.

The embodiments of the present disclosure provide a second device, which includes a processor and a memory. The memory is configured to store a computer program, and the processer is configured to call and run the computer program stored in the memory, to cause the terminal device to perform the above method mentioned in the embodiments of the present disclosure.

The embodiments of the present disclosure provide a chip to implement the above methods mentioned in the embodiments of the present disclosure.

Exemplarily, the chip includes a processor, and the processer is configured to call and run a computer program from a memory, to cause a device equipped with the chip to perform the above methods mentioned in the embodiments of the present disclosure.

The embodiments of the present disclosure provide a computer readable storage medium, which is configured to store a computer program, and the computer program, when being executed by a device, causes the device to perform the above methods mentioned in the embodiments of the present disclosure.

The embodiments of the present disclosure provide a computer program product, which includes computer program instructions. The computer program instructions cause a computer to perform the above methods mentioned in the embodiments of the present disclosure.

The embodiments of the present disclosure provide a computer program, where the computer program, when being executed on a computer, causes the computer to perform the above methods mentioned in the embodiments of the present disclosure.

### BRIEF DESCRIPTION OF THE DRAWINGS

FIG. 1 is a schematic diagram of an application scenario according to embodiments of the present disclosure.

FIG. 2 is a schematic diagram of a cellular-based zero power consumption system according to embodiments of the present disclosure.

FIG. 3 is a schematic diagram of a zero power consumption system using a cellular direct connection with auxiliary power supply according to embodiments of the present disclosure.

FIG. 4 is a schematic diagram of realizing back scattering based on a passive electronic tag according to an embodiment of the present disclosure.

FIG. 5 is another schematic diagram of realizing back scattering based on a passive electronic tag according to an embodiment of the present disclosure.

FIG. 6 is a schematic diagram of realizing power harvesting based on a passive electronic tag according to an embodiment of the present disclosure.

FIG. 7 is a schematic diagram of a resistance load modulation circuit of a passive electronic tag according to an embodiment of the present disclosure.

FIG. 8 is a schematic diagram of an application scenario of realizing zero power consumption communication between a base station and a zero power consumption device of a data transmission method according to an embodiment of the present disclosure.

FIG. 9 is a schematic flowchart of a data transmission method according to embodiments of the present disclosure.

FIG. 10 is a schematic flowchart of a data transmission method according to embodiments of the present disclosure.

FIG. 11 is a schematic flowchart of a data transmission method according to an embodiment of the present disclosure.

FIG. 12 is a schematic flowchart of a data transmission method according to an embodiment of the present disclosure.

FIG. 13 is a schematic flowchart of a data transmission method according to an embodiment of the present disclosure.

FIG. 14 is a schematic flowchart of a data transmission method according to an embodiment of the present disclosure.

FIG. 15 is a schematic flowchart of a data transmission method according to an embodiment of the present disclosure.

FIG. 16 is a schematic flowchart of a data transmission method according to an embodiment of the present disclosure.

FIG. 17 is a schematic diagram of data transmission between a power supply node, a network device and a zero power consumption device of a data transmission method according to an embodiment of the present disclosure.

FIG. 18 is a schematic diagram of data transmission between a network device and a zero power consumption device of an example of a data transmission method according to an embodiment of the present disclosure.

FIG. 19 is a schematic diagram of downlink data transmission between a network device and a zero power consumption device of an example of a data transmission method according to an embodiment of the present disclosure.

FIG. 20 is a schematic diagram of an encapsulation format of a downlink signal in downlink data transmission between a network device and a zero power device of an example of a data transmission method according to an embodiment of the present disclosure.

FIG. 21 is a schematic diagram of uplink data transmission between a network device and a zero power consumption device of an example of a data transmission method according to an embodiment of the present disclosure.

FIG. 22 is a schematic block diagram of a first device according to an embodiment of the present disclosure.

FIG. 23 is a schematic block diagram of a second device according to an embodiment of the present disclosure.

FIG. 24 is a schematic block diagram of a communication device according to embodiments of the present disclosure.

FIG. 25 is a schematic block diagram of a chip according to embodiments of the present disclosure.

FIG. 26 is a schematic block diagram of a communication system according to embodiments of the present disclosure.

### DETAILED DESCRIPTION

Technical solutions in the embodiments of the present disclosure will be described below in conjunction with the accompanying drawings in the embodiments of the present disclosure.

The technical solutions of the embodiments of the present disclosure may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (Non-Terrestrial Networks, NTN) system, a universal mobile telecommunication system (UMTS), wireless local area networks (WLAN), wireless fidelity (WiFi), a fifth-generation communication (5th-Generation, 5G) system, or other communication systems.

Generally speaking, traditional communication systems support a limited number of connections which are easy to be implemented. However, with development of the communication technology, mobile communication systems will support not only the traditional communication, but also, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

Optionally, a communication system in the embodiments of the present disclosure may be applied to a carrier aggregation (CA) scenario, may also be applied to a dual connectivity (DC) scenario, and may also be applied to a standalone (SA) network deployment scenario.

Optionally, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

In the embodiments of the present disclosure, each embodiment will be described in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (STATION, ST) in the WLAN, which may be a cellular phone, a cordless phone, a session initiation protocol (SIP) phone, a wireless local loop (WLL) station, or a personal digital assistant (PDA) device, a handheld device with wireless communication functions, a computing device or other processing devices connected to a wireless modem, an in-vehicle device, a wearable device, a terminal device in a next generation communication system (e.g., an NR network), a terminal device in a future evolved public land mobile network (PLMN) network, or the like.

In the embodiments of the present disclosure, the terminal device may be deployed on land, which includes indoor or outdoor, handheld, wearable, or in-vehicle; the terminal device may also be deployed on water (e.g., on a steamship); and the terminal device may also be deployed in air (e.g., on an airplane, on a balloon, or on a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, or the like.

As an example but not a limitation, in the embodiments of the present disclosure, the terminal device may also be a wearable device. The wearable device may also be referred to as a wearable smart device, which is a generic term for a wearable device by using wearable technology and intelligent design for everyday wear, such as glasses, gloves, a watch, clothing, or shoes. The wearable device is a portable device that is worn directly on a body, or integrated into a user's clothing or accessories. The wearable device is not only a hardware device, but also achieves powerful functions through software supporting as well as data interaction or cloud interaction. Generalized wearable smart devices includes full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets or smart jewelries for monitoring physical signs.

In the embodiments of the disclosure, the network device may be a device used for communicating with a mobile device. The network device may be an access point (AP) in the WLAN, a base station (Base Transceiver Station, BTS) in the GSM or CDMA, may also be a base station (NodeB, NB) in the WCDMA, or may also be an evolutional base station (Evolutional Node B, eNB or eNodeB) in the LTE, a relay station or an access point, a network device (gNB) in an in-vehicle device, a wearable device and an NR network, a network device in the future evolved PLMN network, a network device in the NTN network, or the like.

As an example but not a limitation, in the embodiments of the present disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite. Optionally, the network device may also be a base station deployed on land, water, and other places.

In the embodiments of the present disclosure, the network device may provide services for a cell, and the terminal device communicates with the network device through transmission resources (such as a frequency domain resources, or frequency spectrum resources) used by the cell. The cell may be a cell corresponding to the network device (such as the base station). The cell may belong to a macro base station or a base station corresponding to a small cell. The small cell here may include a metro cell, a micro cell, a pico cell, a femto cell, or the like. These small cells have characteristics of small coverage range and low transmission power, which are applicable for providing a data transmission service with high speed.

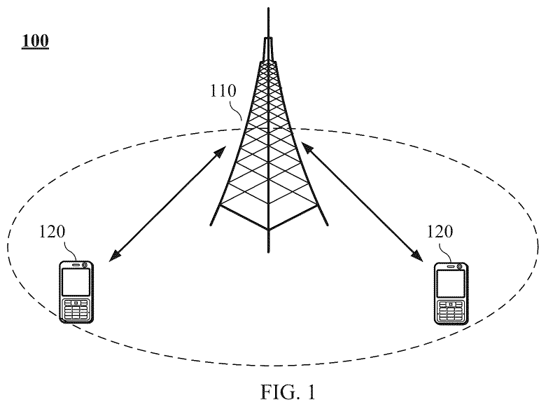

FIG. 1 exemplarily illustrates a communication system 100. The communication system includes one network device 110 and two terminal devices 120. Optionally, the communication system 100 may include multiple network devices 110, and may include other numbers of terminal devices 120 within a coverage range of each network device 110, which is not limited in the embodiments of the present disclosure.

Optionally, the communication system 100 may also include other network entities such as a mobility management entity (MME), an access and mobility management function (AMF), which are not limited in the embodiments of the present disclosure.

The network device may also include an access network device and a core network device. That is, the wireless communication system also includes multiple core networks for communicating with the access network device. The access network device may be a evolutional base station (evolutional node B, abbreviated as eNB or e-NodeB), a macro base station, a micro base station (also referred to as a “small base station”), a pico base station, an access point (AP), a transmission point (TP), a new generation base station (new generation Node B, gNodeB) or the like, in a long-term evolution (LTE) system, a next generation (mobile communication system) (e.g., next radio, NR) system or an authorized auxiliary access long-term evolution (LAA-LTE) system.

It should be understood that a device having a communication function in the network or system in the embodiments of the present disclosure may be referred to as a communication device. Taking the communication system shown in FIG. 1 as an example, the communication device may include the network device and the terminal device with the communication function, and the network device and the terminal device may be specific devices in the embodiments of the present disclosure, which will not be repeated here. The communication device may further include other devices in the communication system, such as a network controller, a mobility management entity, and other network entities, which are not limited in the embodiments of the present disclosure.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that, “indication” mentioned in the embodiments of the present disclosure may be direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated, a relationship of configuring and being configured, or the like.

In order to facilitate understanding of the technical solutions of the embodiments of the present disclosure, related technologies of the embodiments of the present disclosure are described below, and the following related technologies may be, as optional solutions, arbitrarily combined with the technical solutions of the embodiments of the present disclosure, all of which belong to the protection scope of the embodiments of the present disclosure.

With rapid development of communication technologies, related industry applications adapted with a variety of Internet of Things communication technologies have emerged, but there are still a large number of application scenarios of which related requirements are not well met, including but not limited to the following scenarios.
(1) Some Internet of Things scenarios in harsh communication environments, which may face extreme environments such as high temperature, extremely low temperature, high humidity, high pressure, high radiation or high-speed movement, for example, ultra-high voltage power stations, track monitoring of trains in high-speed movement, environmental monitoring in alpine zones, or industrial production lines. In these scenarios, existing Internet of Things terminals will not work due to working environment limitations of conventional power supplies. In addition, extreme working environments are also not conducive to maintain the Internet of Things, such as, battery replacement.
(2) Internet of Things scenarios with extremely small size terminal form requirements, for example, food traceability, commodity circulation and smart wearable requires terminals to have extremely small sizes to facilitate use in these scenarios. For example, Internet of Things terminals used for commodity management in circulation links usually use a form of electronic tags, and the electronic tags need to be embedded into commodity packaging in a very compact form. For example, lightweight wearable devices may improve user experience while meeting user requirements, and it is necessary to design wearable devices to be smaller in size and lighter in weight.
(3) Internet of Things scenarios that meet requirements for extremely low-cost Internet of Things communications, such as logistics or warehousing scenarios. In order to facilitate the management of a large number of items in circulation, an Internet of Things terminal may be attached to each item, so that accurate management of a whole process and a full cycle of logistics are completed through communications between the terminal and a logistics network, which requires that cost of the Internet of Things terminal is sufficiently low, thereby improving theirs competitiveness relative to other alternative technologies.

Internet of Things communication scenarios represented by the above scenarios require Internet of Things communication terminals which support characteristics with battery-free, ultra-low power consumption, extremely small size and extremely low cost. Existing Internet of Things communication technologies are difficult to meet these requirements, but zero power consumption communication technologies using power harvesting and back scattering are expected to become a new generation Internet of Things communication technologies due to their excellent performances such as extremely low power consumption, extremely small size and extremely low cost, thereby solving communication requirements of related application scenarios of the Internet of Things.

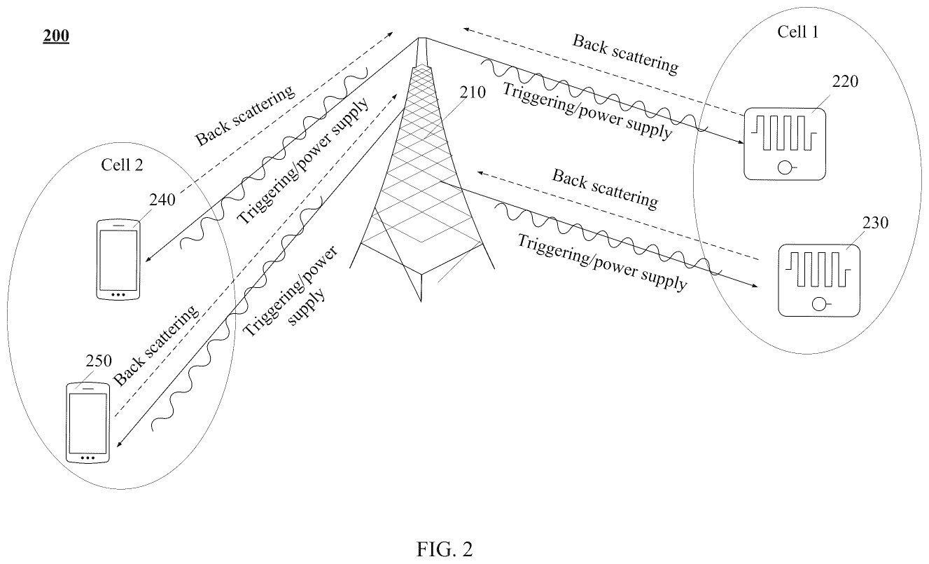

FIG. 2 exemplarily illustrates a cellular-based zero power consumption communication system 200. The zero power consumption communication system 200 includes: a network device and cellular subscribers located in different cells. For example, there are two cellular subscribers (e.g., a terminal device 220 and terminal device 230) in a cell 1, which are evenly distributed around a network device 210 (e.g., a base station), and there are two cellular subscribers (e.g., a terminal device 240 and terminal device 250) in a cell 2, which are evenly distributed around the network device 210 (e.g., the base station). Optionally, the zero power consumption communication system 200 may further include multiple network devices, and a coverage range of each network device may include other numbers of multiple terminal devices, which is not limited in the embodiments of the present disclosure.

The terminal device 220, terminal device 230, terminal device 240 and terminal device 250 may be zero power consumption devices, and the zero power consumption devices do not need to carry their own batteries. Here, the terminal device 220 and terminal device 230 may directly use tags based on a radio frequency identification (RFID) technology, and a RFID tag is also referred to as a “radio frequency tag” or an “electronic tag”. Exemplarily, a passive electronic tag (or an inactive electronic tag) may also be referred to as a back scattering tag due to support back scattering. The terminal device 240 and terminal device 250 may be zero power consumption devices including passive electronic tags. For example, the passive electronic tags are provided inside the terminal device 240 and terminal device 250, the passive electronic tags may be attached outside the terminal device 240 and terminal device 250, or the like. Here, the terminal device 240 and terminal device 250 may be mobile phones, and at least one of the terminal device 240 or terminal device 250 may also be a signal receiver. Types of these terminal devices are not limited, as long as terminal devices that may realize back scattering are within the protection scope of the present disclosure.

As shown in FIG. 2, the zero power consumption communication system 200 uses a communication manner of a cellular direct connection, that is, the network device directly communicate with the zero power consumption device. Before communicating, the zero power consumption device needs to receive a radio power supply signal for performing power harvesting to obtain power required in operation. Accordingly, the network device transmits the radio power supply signal and a trigger signal to the zero power consumption device. Here, the radio power supply signal is used to supply power for the zero power consumption device, and may be a carrier signal transmitted by the network device. The trigger signal may use a same carrier signal as the radio power supply signal. Control information, data information or the like transmitted to the zero power consumption device may be carried in the carrier signal. The zero power consumption device modulates the carrier signal to obtain a back scattering signal, and transmits the back scattering signal to the network device in a back scattering manner.

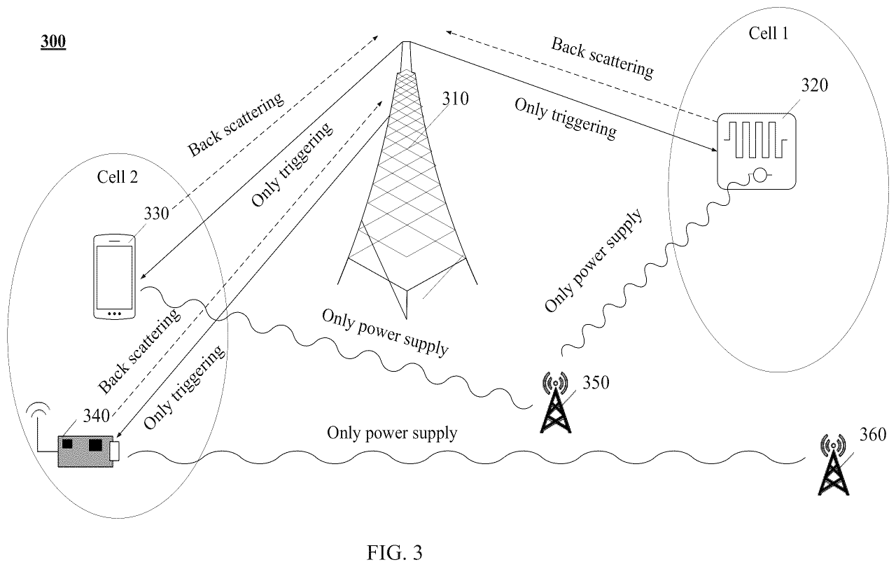

FIG. 3 exemplarily illustrates another cellular-based zero power consumption communication system 300. The zero power consumption communication system 300 includes: a network device, cellular subscribers located in different cells and a third-party device for supplying power. For example, there is one cellular subscriber (e.g., a terminal device 320) in a cell 1, which is distributed around a network device 310 (e.g., a base station), and there are two cellular subscriber (e.g., a terminal device 330 and terminal device 340) in a cell 2, which are evenly distributed around a network device 310 (e.g., the base station). Optionally, the zero power consumption communication system 300 may further include multiple network devices, and a coverage range of each network device may include other numbers of multiple terminal devices. There are one or more third-party devices, such as a power supply node 350 that supplies power to the terminal device 320 and terminal device 330, and a power supply node 360 that supplies power to the terminal device 340, which are not limited in the embodiments of the present disclosure.

The terminal device 320, terminal device 330 and terminal device 340 may be zero power consumption devices, and the zero power consumption devices do not need to carry their own batteries. Here, the terminal device 320 may directly use an RFID tag, and the RFID tag is also referred to as a “radio frequency tag” or an “electronic tag”. Exemplarily, a passive electronic tag (or an inactive electronic tag) may also be referred to as a back scattering tag due to support back scattering. The terminal device 330 and terminal device 340 may be zero power consumption devices including passive electronic tags. For example, the passive electronic tags may be provided inside the terminal device 330 and terminal device 340, the passive electronic tags may be attached outside the terminal device 330 and terminal device 340, or the like. Here, the terminal device 330 may be a mobile phone, and the terminal device 340 may be a signal receiver. Types of these terminal devices are not limited, as long as terminal devices that may realize back scattering are within the protection scope of the present disclosure.

In a case of the third-party device being a power supply node, which may be a base station, a mobile phone, a relay node, a customer premise equipment (CPE), or the like in a network. Where necessary, a dedicated power supply node may also be deployed. Radio communication signals (such as, synchronization signals, broadcast signals or data signals) transmitted by these power supply nodes may be used to provide radio power supply for the zero power consumption device, or these power supply nodes may also transmit dedicated radio power supply signals based on a reasonable scheduling manner.

As shown in FIG. 3, the zero power consumption communication system 300 uses a communication manner of a cellular direct connection with auxiliary power supply, that is, the zero power consumption device may obtain radio power supply not only from a network device communicating with the zero power consumption device, but also from a third-party device. Before communicating, the zero power consumption device needs to receive a radio power supply signal transmitted by the third party device, and obtains power through a radio power supply manner for perform power harvesting, to obtain power required in operation. Considering that a strength of a power supply signal reaching the terminal device needs to meet a certain threshold, such as −20 dBm or −30 dBm, which causes that a coverage range of the power supply signal transmitted by the network device is relatively small (generally in a range of tens of meters to 100 meters) in a case of limited transmission power of the power supply signal. From a perspective of coverage of the cellular cell, a coverage range of the radio power supply is much smaller than that of a data transmission signal. More power supply nodes are needed to realize the radio power supply, to significantly improve the coverage range of the radio power supply, thereby improving cell coverage of the zero power consumption communication as much as possible. For this purpose, other nodes in the network other than the network device (such as the base station) may be used for radio power supply, for example, power supply nodes that may be used include a mobile phones, a relay nodes, a CPE, and the like in the network. Where necessary, a dedicated power supply node may also be deployed. These power supply nodes transmit the radio power supply signals to the zero power consumption device, and the network device transmit a trigger signal to the zero power consumption device. Here, the radio power supply signal is used to supply power for the zero power consumption device, and may be a carrier signal. The trigger signal may use a different carrier signal from the radio power supply signal. Control information, data information or the like transmitted to the zero power consumption device may be carried in the carrier signal. The zero power consumption device modulates the carrier signal to obtain a back scattering signal, and transmits the back scattering signal to the network device in a back scattering manner.

As shown in FIG. 4, a zero power consumption device is the above passive electronic tag, or the zero power consumption device may include the above passive electronic tag. The passive electronic tag includes a power harvesting module (used for power harvesting), a back scattering communication module (used for back scattering communication), a low power consumption computing module (used for low power consumption computing) and a sensor module (used for data collecting and reporting), where the low power consumption computing module and the sensor module are optional modules. Transmitting a power supply signal (such as, a radio wave) to the zero power consumption device by a network device (including but not limited to providing a reader/writer in the network device or the network device supporting read/write processing performed by the reader/writer), may supply power required in operation for the zero power consumption device. Exemplarily, the zero power consumption device may harvest power carried by the radio wave in space through the power harvesting module, so as to drive the back scattering communication module, the low power consumption computing module and the sensor module to operate through the power harvesting module, and realize the back scattering communication finally. After obtaining the power required in operation, the zero power consumption device may further receive a trigger signal transmitted by the network device (such as, a control command transmitted by a set reader/writer). The zero power consumption device responds to the trigger signal and establishes the back scattering communication with the network device in a back scattering manner, for example, it may receive downlink data transmitted by the network device it may also transmit uplink data requested by the network device. The transmitted uplink data may come from data stored by the zero power consumption terminal itself (for example, an identifier or pre-written information, such as a production date, a brand, a manufacturer of a product).

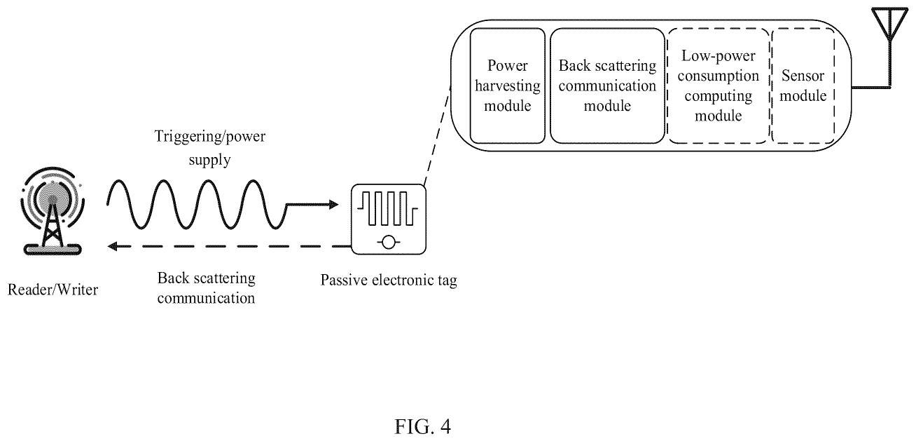

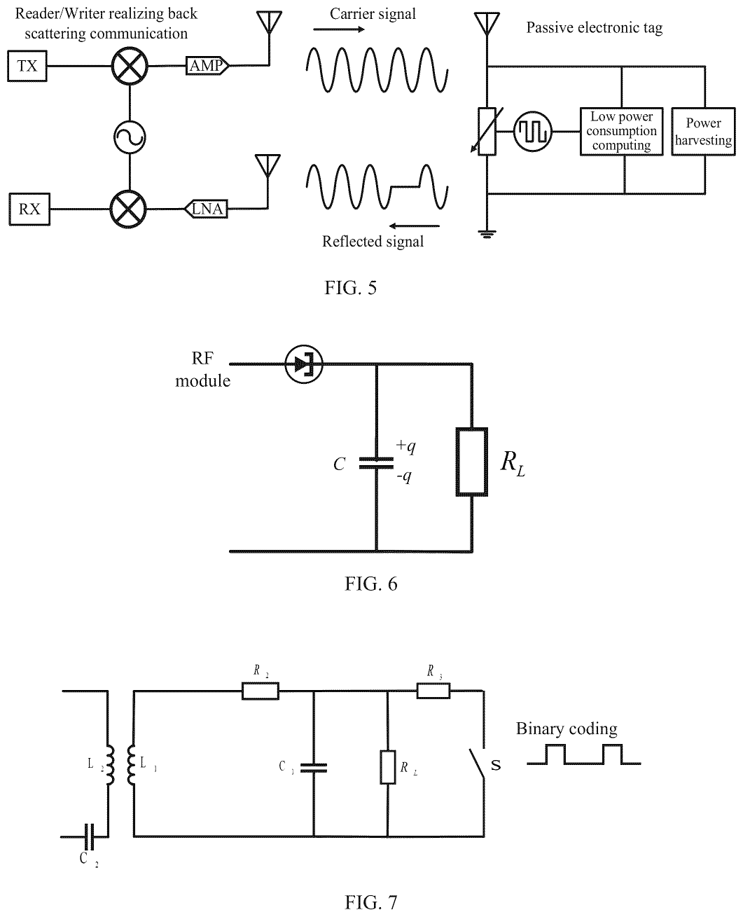

As shown in FIG. 5, a zero power consumption device is the above passive electronic tag, or the zero power consumption device may include the above passive electronic tag. The passive electronic tag receives a carrier signal, harvests power through a power harvesting module, supplies power to a low power consumption computing module through the power harvesting module, and performs back scattering communication after performing modulation on the carrier signal.

As shown in FIG. 6, a zero power consumption device is the above passive electronic tag, or the zero power consumption device may include the above passive electronic tag. The passive electronic tag uses a power harvesting module (denoted as RF module) to harvest space electromagnetic wave power through electromagnetic induction, and then drives a load circuit (a load circuit consisting of a capacitor and a resistor), so as to drive a back scattering communication module, a low power consumption computing module and a sensor module to operate through the power harvesting module, and realize back scattering communication finally.

As shown in FIG. 7, load modulation is an adjustment method for a passive electronic tag to transmit data to a reader/writer. Exemplarily, the load modulation completes a modulation process mainly by adjusting electrical parameters of an oscillation circuit of the passive electronic tag according to a beat of data stream to change a size and phase of impedance of the passive electronic tag accordingly. There are two main adjustment schemes in the load modulation, which are resistive load modulation and capacitive load modulation. In the resistive load modulation, a load is connected in parallel with a resistor, which is referred to as a load modulation resistor. The resistor is turned on and off according to a clock of the data stream, and the on-off of a switch S is controlled by binary data coding. In the capacitive load modulation, comparing to the resistive load modulation, a load is paralleled by a capacitor, replacing the load modulation resistor controlled by the binary data coding shown in FIG. 7.

To sum up, considering increasing types of connected objects and application scenarios in Internet of Things, in order to realize Internet of Everything and avoid a problem of high power consumption caused by traditional terminal devices requiring batteries supply power in a cellular network, a zero power consumption device is introduced in the cellular network. Since the zero power consumption device is the above passive electronic tag, or the zero power consumption device may include the above passive electronic tag, power may be harvest through a power harvesting module in the passive electronic tag without relying on a traditional active power amplifier transmitter, and a low power consumption computing unit is used in the passive electronic tag, thereby greatly reducing hardware complexity. Moreover, the zero power consumption device does not actively transmit signals and realizes back scattering communication by adjusting a received carrier signal, so that battery-free and zero power consumption back scattering communication may be realized by using a battery-free zero power consumption device, which not only meets communication requirements of related application scenarios of the Internet of Things, but also reduces investment cost of related communication system of the Internet of Things.

Taking data transmission of uplink data/downlink data as an example, a network device may perform data transmission based on back scattering with multiple zero power consumption devices. Considering that there are multiple terminal devices, it is necessary to distinguish different devices to ensure correct data transmission and meet data transmission requirements of zero power consumption between the multiple devices.

The embodiments of the present disclosure provide a data transmission method, which is applied to a first device and includes:
receiving, by the first device, a downlink signal transmitted by a second device, the downlink signal carrying a terminal identifier;
identifying, by the first device, that the terminal identifier is a self identifier of the first device; and
transmitting, by the first device, an uplink signal to the second device according to the downlink signal;
where the first device is a zero power consumption device.

In some embodiments, the downlink signal is used to supply power for the first device; or the first device receives a power supply signal, and the power supply signal is used to supply power for the first device.

In some embodiments, in a case where the downlink signal includes a first signal and a second signal, the first signal is used to carry the terminal identifier, and the second signal is used to carry downlink data or an indication of uplink data.

In some embodiments, in a case where the downlink signal includes a first field and a second field, the first field is used to carry the terminal identifier, and the second field is used to carry downlink data or an indication of uplink data.

In some embodiments, where identifying, by the first device, that the terminal identifier is the self identifier of the first device, and transmitting, by the first device, the uplink signal to the second device according to the downlink signal includes:
obtaining, by the first device, the terminal identifier from the first signal received;
identifying, by the first device, that the terminal identifier is the self identifier of the first device, and receiving, by the first device, the second signal;
determining, by the first device, the uplink signal according to whether the downlink data in the second signal is successfully received; and
transmitting, by the first device, the uplink signal to the second device.

In some embodiments, where determining, by the first device, the uplink signal according to whether the downlink data in the second signal is successfully received includes:
determining, in a case where the downlink data is successfully received, that the uplink signal is an acknowledgement (ACK); or
determining, in a case where the downlink data is not successfully received, that the uplink signal is a negative acknowledgement (NACK).

In some embodiments, there is a time interval between the first signal and the second signal.

In some embodiments, where identifying, by the first device, that the terminal identifier is the self identifier of the first device, and transmitting, by the first device, the uplink signal to the second device according to the downlink signal includes:
performing, by the first device, demodulating on the downlink signal to obtain the terminal identifier;
identifying, by the first device, that the terminal identifier is the self identifier of the first device, and receiving, by the first device, the downlink data;
determining, by the first device, the uplink signal according to whether the downlink data is successfully received; and
transmitting, by the first device, the uplink signal to the second device.

In some embodiments, where determining, by the first device, the uplink signal according to whether the downlink data is successfully received includes:
determining, in a case where the downlink data is successfully received, that the uplink signal is an acknowledgement (ACK); or
determining, in a case where the downlink data is not successfully received, that the uplink signal is a negative acknowledgement (NACK).

In some embodiments, where identifying, by the first device, that the terminal identifier is the self identifier of the first device, and transmitting, by the first device, the uplink signal to the second device according to the downlink signal includes:
obtaining, by the first device, the terminal identifier from the downlink signal;
performing, by the first device, descrambling of a CRC check according to the terminal identifier, identifying, by the first device, that the terminal identifier is the self identifier of the first device in a case of successful descrambling, and receiving, by the first device, the downlink data;
determining, by the first device, the uplink signal according to whether the downlink data is successfully received; and
transmitting, by the first device, the uplink signal to the second device.

In some embodiments, where determining, by the first device, the uplink signal according to whether the downlink data is successfully received includes:
determining, in a case where the downlink data is successfully received, that the uplink signal is an acknowledgement (ACK); or
determining, in a case where the downlink data is not successfully received, that the uplink signal is a negative acknowledgement (NACK).

In some embodiments, the method further includes:
respectively marking the ACK and the NACK by means of different sequences.

In some embodiments, where identifying, by the first device, that the terminal identifier is the self identifier of the first device, and transmitting, by the first device, the uplink signal to the second device according to the downlink signal includes:
obtaining, by the first device, the terminal identifier from the first signal received;
identifying, by the first device, that the terminal identifier is the self identifier of the first device, and receiving, by the first device, the second signal; and
transmitting, by the first device, the uplink signal to the second device according to the indication of uplink data in the second signal; where the uplink signal includes the uplink data.

In some embodiments, there is a time interval between the first signal and the second signal.

In some embodiments, where identifying, by the first device, that the terminal identifier is the self identifier of the first device, and transmitting, by the first device, the uplink signal to the second device according to the downlink signal includes:
performing, by the first device, demodulation on the downlink signal to obtain the terminal identifier;
identifying, by the first device, that the terminal identifier is the self identifier of the first device, and receiving, by the first device, the indication of uplink data; and
transmitting, by the first device, the uplink signal to the second device according to the indication of uplink data; where the uplink signal includes the uplink data.

In some embodiments, where identifying, by the first device, that the terminal identifier is the self identifier of the first device, and transmitting, by the first device, the uplink signal to the second device according to the downlink signal includes:
obtaining, by the first device, the terminal identifier from the downlink signal;
performing, by the first device, descrambling of a CRC check according to the terminal identifier, identifying, by the first device, that the terminal identifier is the self identifier of the first device in a case of successful descrambling, and receiving, by the first device, the indication of uplink data; and
transmitting, by the first device, the uplink signal to the second device according to the indication of uplink data; where the uplink signal includes the uplink data.

In some embodiments, the method further includes:
performing scrambling on the uplink signal by a CRC check manner.

In some embodiments, the terminal identifier is an identifier registered when the first device initially accesses a network.

The embodiments of the present disclosure provide a data transmission method, which is applied to a second device and includes:
transmitting, by the second device, a downlink signal to a first device, the downlink signal carrying a terminal identifier; and
receiving, by the second device, an uplink signal;
where the uplink signal is a signal obtained according to the downlink signal in a case where the first device performs identification based on the terminal identifier, and the first device is a zero power consumption device.

In some embodiments, the method further includes:
using, by the second device, the downlink signal to supply power for the first device; or
transmitting, by the second device, a power supply signal, and using, by the second device, the power supply signal to supply power for the first device.

In some embodiments, in a case where the downlink signal includes a first signal and a second signal, the first signal is used to carry the terminal identifier, and the second signal is used to carry downlink data or an indication of uplink data.

In some embodiments, in a case where the downlink signal includes a first field and a second field, the first field is used to carry the terminal identifier, and the second field is used to carry downlink data or an indication of uplink data.

In some embodiments, the uplink signal includes an acknowledgement (ACK) or a negative acknowledgement (NACK); where the ACK is used to describe that the downlink data is successfully received by the first device, and the NACK is used to describe that the downlink data is not successfully received by the first device.

In some embodiments, the uplink signal includes uplink data, where the uplink data is used to describe data obtained by the first device according to the indication of uplink data.

In some embodiments, the terminal identifier is an identifier registered when the first device initially accessed a network.

FIG. 8 is a schematic diagram of another application scenario according to the embodiments of the present disclosure, and exemplarily illustrates a data transmission method 800 according to the embodiments of the present disclosure. Taking a network device as a base station and a terminal device as a mobile phone as an example, a base station 811 communicates with a mobile phone 821, mobile phone 831 and mobile phone 841. At least one of the mobile phone 821, mobile phone 831 and mobile phone 841 is a mobile phone carrying a passive electronic tag. Taking data transmission between the base station 811 and the mobile phone 841 (that is, a mobile phone including the passive electronic tag) as an example, a data transmission process includes some or all of the following operations.

S810, the base station 811 transmits a carrier signal, where the carrier signal includes a trigger signal for triggering back scattering communication (the trigger signal carries a terminal identifier) and a power supply signal.

S820, the mobile phone 841 receives the power supply signal to obtain power required in operation, the mobile phone 841 receives the trigger signal to obtain the terminal identifier carried in the trigger signal, and the mobile phone 841 identifies the terminal identifier as a self identifier of the terminal device, and triggers the back scattering communication.

S830, the mobile phone 841 transmits a reflected signal to the base station 811, and establishes the back scattering communication with the base station 811, where the reflected signal is obtained from the carrier signal.

There is no inevitable sequential relationship between the operations S810 to S830, and some of the operations may be selected to execute as necessary, and it is unnecessary to sequentially execute the above operations.

The above data transmission between the base station and the mobile phone realized based on back scattering is merely an example, and the embodiments of the present disclosure is not limited to the example, and may be data transmission between multiple devices in other scenarios of the Internet of Things, such as, data transmission between an intelligent control center and multiple terminal devices in a warehousing scenario of the Internet of Things.

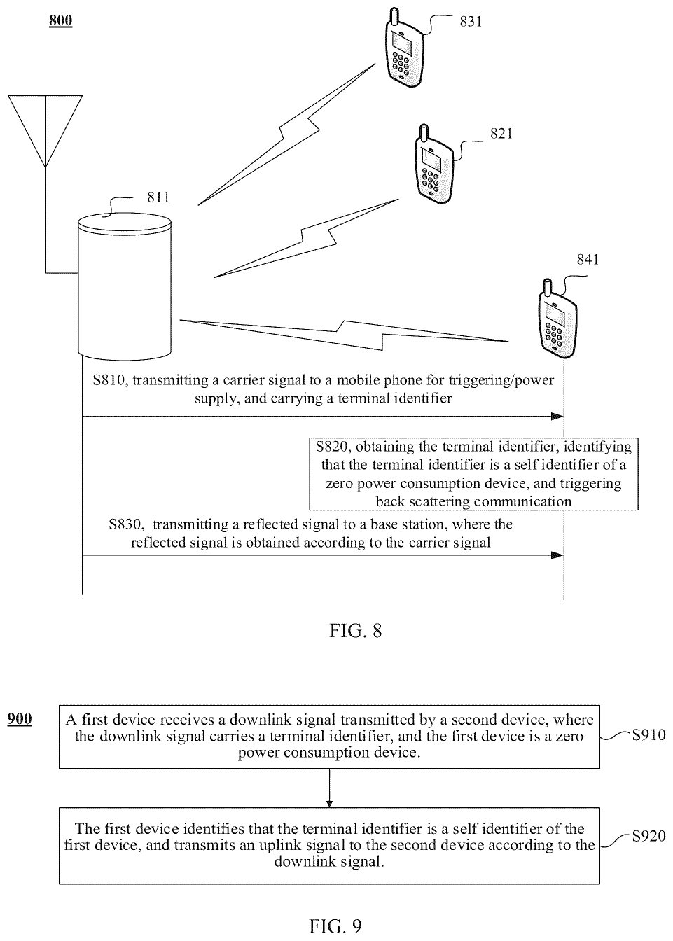

FIG. 9 is a schematic flowchart of a data transmission method 900 according to an embodiment of the present disclosure. Optionally, the method may be applied to the system shown in FIG. 1, but is not limited thereto. The method includes at least part of the following content.

S910, a first device receives a downlink signal transmitted by a second device, where the downlink signal carries a terminal identifier, and the first device is a zero power consumption device.

In some examples, the first device may be a terminal device, and the second device may be a network device, where the first device is a zero power consumption device including a passive electronic tag. Through the passive electronic tag, the zero power consumption device may not only realize data transmission with the network device based on back scattering communication, but also meet data transmission requirements of zero power consumption.

S920, the first device identifies that the terminal identifier is a self identifier of the first device, and transmits an uplink signal to the second device according to the downlink signal.

In some examples, the first device may be the terminal device, and the second device may be the network device, where the first device is the zero power consumption device. Since there may be multiple zero power consumption devices communicating with the network device, it is necessary to distinguish which zero power consumption device the downlink signal transmitted by the network device is for. The zero power consumption device compares the terminal identifier carried by the downlink signal with a self identifier of the zero power consumption device, and in a case where the terminal identifier carried by the downlink signal is identified as the self identifier of the zero power consumption device, it is clear that the downlink signal transmitted by the network device is for the zero power consumption device itself, thereby transmitting the uplink signal to the second device according to the downlink signal.

According to the embodiments of the present disclosure, the first device (such as, the zero power consumption device) may receive the downlink signal transmitted by the second device, and the downlink signal carries the terminal identifier. The first device identifies that the terminal identifier is the self identifier of the first device, and transmits the uplink signal to the second device according to the downlink signal. The first device is the zero power consumption device that does not require a battery to supply power and may realize data transmission between the first device and second device through back scattering communication. Moreover, in a case where the first device identifies that the terminal identifier is the self identifier of the first device, different terminal devices may be distinguished. Therefore, not only can different devices be distinguished, but also data transmission requirements of zero power consumption can be met.

In a possible implementation, at least one of the following schemes (1) to (2) is included:
(1) the downlink signal is used to supply power for the first device. For example, the first device is the zero power consumption device, and the second device is the network device, such as, a base station. A carrier signal transmitted by the base station is used as the downlink signal, the downlink signal itself may supply power for the zero power consumption device, and the downlink signal and a power supply signal are the same; or
(2) the first device receives a power supply signal, and the power supply signal is used to supply power for the first device. For example, the first device is the zero power consumption device and requires a signal other than the downlink signal as the power supply signal, and the power supply signal may be a carrier signal transmitted by another power supply nodes other than the base station in the network (a mobile phone, a relay node, or a CPE in the network, a deployed dedicated power supply node, or the like), and the downlink signal and the power supply signal are different.

In a possible implementation, the downlink signal may include two signals, and in a case where the downlink signal includes a first signal and a second signal, the first signal is used to carry the terminal identifier, and the second signal is used to carry downlink data or an indication of uplink data. For example, the first signal may be a trigger signal carrying the terminal identifier, and the second signal may be a data signal carrying the downlink data or the indication of uplink data, where the downlink data is data transmitted by the second device (the network device) to the first device (the zero power consumption device), and the indication of uplink data is used for the second device (the network device) to request uplink data to be received from the first device (the zero power consumption device).

In a possible implementation, the downlink signal may include one signal, and in a case where the downlink signal includes a first field and a second field, the first field is used to carry the terminal identifier, and the second field is used to carry downlink data or an indication of uplink data. Where the downlink data is data transmitted by the second device (the network device) to the first device (the zero power consumption device), and the indication of uplink data is used for the second device (the network device) to request uplink data to be received from the first device (the zero power consumption device).

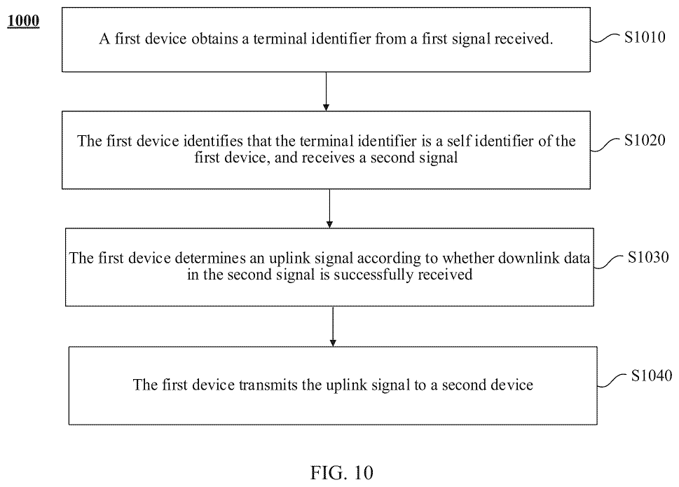

In a possible implementation, an identification of the terminal identifier includes at least one of the following scheme one to scheme three.
I. Time division: for a transmission scenario of downlink data, in case where the downlink signal includes two signals, a first signal is used to carry a terminal identifier, and a second signal is used to carry the downlink data. As shown in FIG. 10, the first device identifies that the terminal identifier is the self identifier of the first device, and transmits the uplink signal to the second device according to the downlink signal, which includes at least part of the following content.

S1010, a first device obtains the terminal identifier from the first signal received.

In some examples, the first device is a zero power consumption device, and the zero power consumption device obtains the terminal identifier from the first signal, where the terminal identifier is an identifier registered when the zero power consumption device initially accesses a network.

S1020, the first device identifies that the terminal identifier is the self identifier of the first device, and receives the second signal.

In some examples, the first device is the zero power consumption device, the second device is a network device. The zero power consumption device compares the terminal identifier obtained from the first signal with a self identifier of the zero power consumption device, and in a case where the terminal identifier obtained from the first signal is identified as the self identifier of the zero power consumption device, it is clear that the second signal transmitted by the network device is for the zero power consumption device itself, thereby receiving the second signal to obtain the downlink data from the second signal.

In some examples, there is a time interval between the first signal and the second signal.

S1030, the first device determines the uplink signal according to whether the downlink data in the second signal is successfully received.

In some examples, in a case where the downlink data is successfully received, it is determined that the uplink signal is an acknowledgement (ACK), in other words, when the downlink data is successfully received, the uplink signal is the ACK.

In some examples, in a case where the downlink data is not successfully received, it is determined that the uplink signal is a negative acknowledgement (NACK), in other words, when the downlink data is not successfully received, the uplink signal is the NACK.

In some examples, the ACK and the NACK are respectively marked by means of different sequences.

S1040, the first device transmits the uplink signal to the second device.

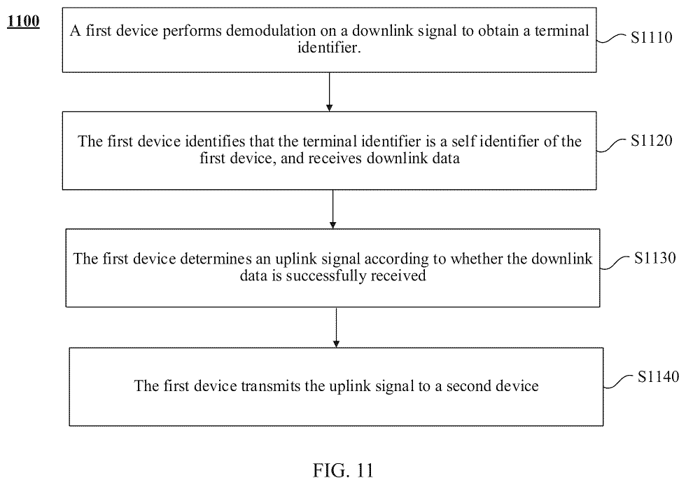

In some examples, the first device is the zero power consumption device, the second device is the network device. The zero power consumption device transmits the ACK or NACK to the network device after determining that the uplink signal is the ACK or NACK according to whether the downlink data in the second signal is successfully received.
II. Modulation: for a transmission scenario of downlink data, in a case where the downlink signal includes one signal, the downlink signal includes a first field and a second field, the first field is used to carry a terminal identifier, and the second field is used to carry downlink data. As shown in FIG. 11, the first device identifies that the terminal identifier is the self identifier of the first device, and transmits the uplink signal to the second device according to the downlink signal, which includes at least part of the following content.

S1110, a first device performs demodulation on the downlink signal to obtain the terminal identifier.

In some examples, the first device is a zero power consumption device, and the zero power consumption device obtains the terminal identifier from the first field through demodulation, where the terminal identifier is an identifier registered when the zero power consumption device initially accesses a network.

S1120, the first device identifies that the terminal identifier is the self identifier of the first device, and receives the downlink data.

In some examples, the first device is the zero power consumption device, the second device is a network device. The zero power consumption device compares the terminal identifier obtained from the first field with a self identifier of the zero power consumption device, and in a case where the terminal identifier obtained from the first field is identified as the self identifier of the zero power consumption device, it is clear that the downlink signal transmitted by the network device is for the zero power consumption device itself, thereby receiving the downlink signal to obtain the downlink data from the second field of the downlink signal.

S1130, the first device determines the uplink signal according to whether the downlink data is successfully received.

In some examples, in a case where the downlink data is successfully received, it is determined that the uplink signal is an ACK, in other words, when the downlink data is successfully received, the uplink signal is the ACK.

In some examples, in a case where the downlink data is not successfully received, it is determined that the uplink signal is a NACK, in other words, when the downlink data is not successfully received, the uplink signal is the NACK.

In some examples, the ACK and the NACK are respectively marked by means of different sequences.

S1140, the first device transmits the uplink signal to the second device.

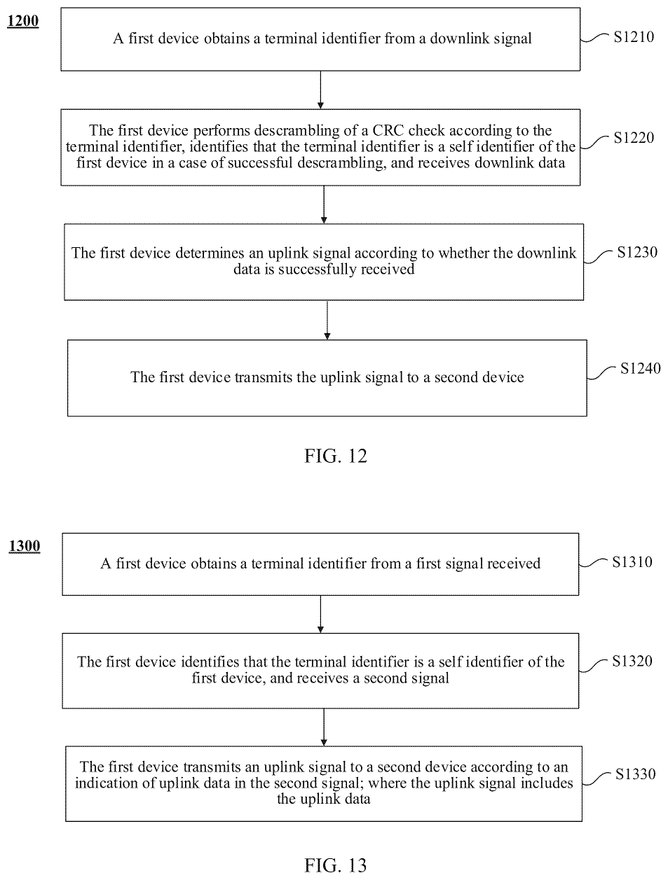

In some examples, the first device is the zero power consumption device, the second device is the network device. The zero power consumption device transmits the ACK or NACK to the network device after determining that the uplink signal is the ACK or NACK according to whether the downlink data in the downlink signal is successfully received.
III. Descrambling of a cyclic redundancy check (CRC) check: for a transmission scenario of downlink data, in a case where the downlink signal includes one signal, the downlink signal includes a first field and a second field, the first field is used to carry a terminal identifier, and the second field is used to carry downlink data. As shown in FIG. 12, the first device identifies that the terminal identifier is the self identifier of the first device, and transmits the uplink signal to the second device according to the downlink signal, which includes at least part of the following content.

S1210, a first device obtains the terminal identifier from the downlink signal.

In some examples, the first device is a zero power consumption device, and the zero power consumption device obtains the terminal identifier from the first field through descrambling, where the terminal identifier is an identifier registered when the zero power consumption device initially accesses a network.

S1220, the first device performs descrambling of a CRC check according to the terminal identifier, identifies that the terminal identifier is the self identifier of the first device in a case of successful descrambling, and receives the downlink data.

In some examples, the first device is the zero power consumption device, the second device is a network device. Descrambling of the CRC check is performed by using the self identifier of the zero power consumption device, and the terminal identifier obtained from the first field is identified as the self identifier of the zero power consumption device in a case where the descrambling is successful, it is clear that the downlink signal transmitted by the network device is for the zero power consumption device itself, thereby receiving the downlink signal to obtain the downlink data from the second field of the downlink signal.

S1230, the first device determines the uplink signal according to whether the downlink data is successfully received.

In some examples, in a case where the downlink data is successfully received, it is determined that the uplink signal is an ACK, in other words, when the downlink data is successfully received, the uplink signal is the ACK.

In some examples, in a case where the downlink data is not successfully received, it is determined that the uplink signal is a NACK, in other words, when the downlink data is not successfully received, the uplink signal is the NACK.

In some examples, the ACK and the NACK are respectively marked by means of different sequences.

S1240, the first device transmits the uplink signal to the second device.

In some examples, the first device is the zero power consumption device, the second device is the network device. The zero power consumption device transmits the ACK or NACK to the network device after determining that the uplink signal is the ACK or NACK according to whether the downlink data in the downlink signal is successfully received.

In a possible implementation, an identification of the terminal identifier includes at least one of the following scheme one to scheme three.
I. Time division: for a transmission scenario of uplink data, in a case where downlink signal includes two signals, a first signal is used to carry a terminal identifier, and a second signal is used to carry an indication of uplink data. As shown in FIG. 13, the first device identifies that the terminal identifier is the self identifier of the first device, and transmits the uplink signal to the second device according to the downlink signal, which includes at least part of the following content.

S1310, a first device obtains the terminal identifier from the first signal received.

In some examples, the first device is a zero power consumption device, and the zero power consumption device obtains the terminal identifier from the first signal, where the terminal identifier is an identifier registered when the zero power consumption device initially accesses a network.

S1320, the first device identifies that the terminal identifier is the self identifier of the first device, and receives the second signal.

In some examples, the first device is the zero power consumption device, the second device is a network device. The zero power consumption device compares the terminal identifier obtained from the first signal with a self identifier of the zero power consumption device, and in a case where the terminal identifier obtained from the first signal is identified as the self identifier of the zero power consumption device, it is clear that the second signal transmitted by the network device is for the zero power consumption device itself, thereby receiving the second signal to obtain the indication of uplink data from the second signal.

In some examples, there is a time interval between the first signal and the second signal.

S1330, the first device transmits the uplink signal to the second device according to the indication of uplink data in the second signal; where the uplink signal includes the uplink data.

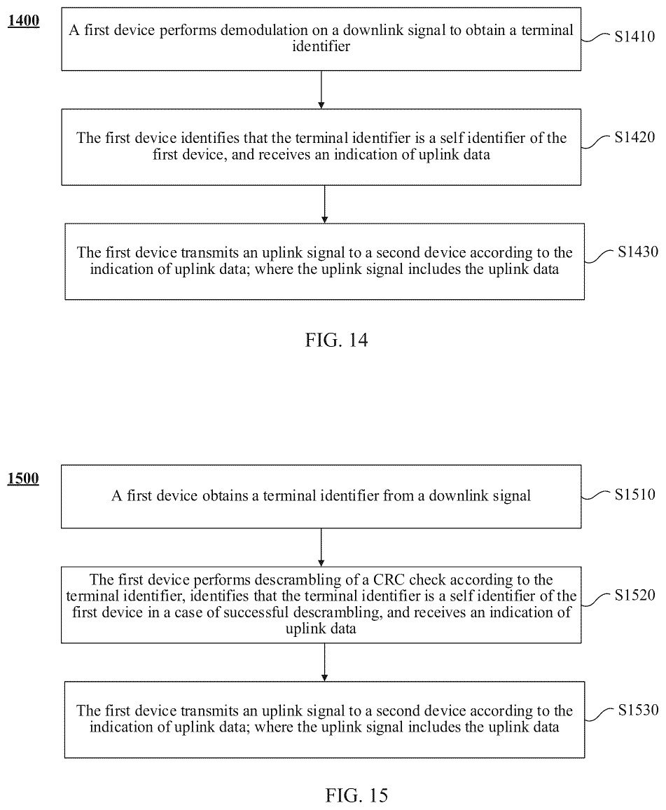

In some examples, the first device is the zero power consumption device, the second device is the network device. The zero power consumption device obtains the indication of uplink data from the second signal, the indication of uplink data is used for the network device to request uplink data to be received from the zero power consumption device, and the zero power consumption device transmits the uplink signal including the uplink data to the network device in response to the indication of uplink data.
II. Modulation: for a transmission scenario of uplink data, in a case where the downlink signal includes one signal, the downlink signal includes a first field and a second field, the first field is used to carry a terminal identifier, and the second field is used to carry an indication of uplink data. As shown in FIG. 14, the first device identifies that the terminal identifier is the self identifier of the first device, and transmits the uplink signal to the second device according to the downlink signal, which includes at least part of the following content.

S1410, a first device performs demodulation on the downlink signal to obtain the terminal identifier.

In some examples, the first device is a zero power consumption device, and the zero power consumption device obtains the terminal identifier from the first field through demodulation, where the terminal identifier is an identifier registered when the zero power consumption device initially accesses a network.

S1420, the first device identifies that the terminal identifier is the self identifier of the first device, and receives the indication of uplink data.

In some examples, the first device is the zero power consumption device, the second device is a network device. The zero power consumption device compares the terminal identifier obtained from the first field with a self identifier of the zero power consumption device, and in a case where the terminal identifier obtained from the first field is identified as the self identifier of the zero power consumption device, it is clear that the downlink signal transmitted by the network device is for the zero power consumption device itself, thereby receiving the downlink signal to obtain the indication of uplink data from the second field of the downlink signal.

S1430, the first device transmits the uplink signal to the second device according to the indication of uplink data; where the uplink signal includes the uplink data.

In some examples, the first device is the zero power consumption device, the second device is the network device. The zero power consumption device obtains the indication of uplink data from the second field, the indication of uplink data is used for the network device to request uplink data to be received from the zero power consumption device, and the zero power consumption device transmits the uplink signal including the uplink data to the network device in response to the indication of uplink data.
III. Descrambling of CRC check: for a transmission scenario of uplink data, in a case where the downlink signal includes one signal, the downlink signal includes a first field and a second field, the first field is used to carry a terminal identifier, and the second field is used to carry an indication of uplink data. As shown in FIG. 15, the first device identifies that the terminal identifier is the self identifier of the first device, and transmits the uplink signal to the second device according to the downlink signal, which includes at least part of the following content.

S1510, a first device obtains the terminal identifier from the downlink signal.

In some examples, the first device is a zero power consumption device, and the zero power consumption device obtains the terminal identifier from the first field through descrambling, where the terminal identifier is an identifier registered when the zero power consumption device initially accesses a network.

S1520, the first device performs descrambling of a CRC check according to the terminal identifier, identifies that the terminal identifier is the self identifier of the first device in a case of successful descrambling, and receives the indication of uplink data.

In some examples, the first device is the zero power consumption device, the second device is a network device. Descrambling of the CRC check is performed by using the self identifier of the zero power consumption device, and the terminal identifier obtained from the first field is identified as the self identifier of the zero power consumption device in a case where the descrambling is successful, it is clear that the downlink signal transmitted by the network device is for the zero power consumption device itself, thereby receiving the downlink signal to obtain the indication of uplink data from the second field of the downlink signal.

S1530, the first device transmits the uplink signal to the second device according to the indication of uplink data; where the uplink signal includes the uplink data.

In some examples, the first device is the zero power consumption device, the second device is the network device. The zero power consumption device obtains the indication of uplink data from the second field, the indication of uplink data is used for the network device to request uplink data to be received from the zero power consumption device, and the zero power consumption device transmits the uplink signal including the uplink data to the network device in response to the indication of uplink data.

In some examples, scrambling is performed on the uplink signal by a CRC check manner.

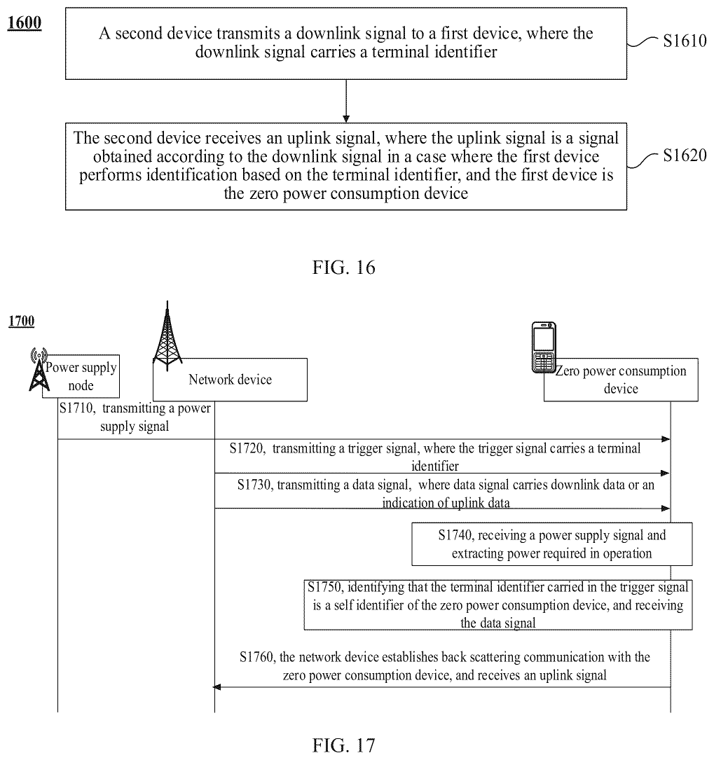

FIG. 16 is a schematic flowchart of a data transmission method 1600 according to an embodiment of the present disclosure. Optionally, the method may be applied to the system shown in FIG. 1, but is not limited thereto. The method includes at least part of the following content.

S1610, a second device transmits a downlink signal to a first device, where the downlink signal carries a terminal identifier.

In some examples, the second device is a network device, the first device is a zero power consumption device. The network device transmits the downlink signal to the zero power consumption device, and the zero power consumption device may obtain the terminal identifier from the downlink signal, where the terminal identifier is an identifier registered when the zero power consumption device initially accesses a network.

S1620, the second device receives an uplink signal, where the uplink signal is a signal obtained according to the downlink signal in a case where the first device performs identification based on the terminal identifier, and the first device is the zero power consumption device.

In some examples, the second device is the network device, the first device is the zero power consumption device. The network device transmits the downlink signal to the zero power consumption device. Since there may be multiple zero power consumption devices communicating with the network device, it is necessary to distinguish which zero power consumption device the downlink signal transmitted by the network device is for. The zero power consumption device compares the terminal identifier carried by the downlink signal with a self identifier of the zero power consumption device, and in a case where the terminal identifier carried by the downlink signal is identified as the self identifier of the zero power consumption device, it is clear that the downlink signal transmitted by the network device is for the zero power consumption device itself, thereby transmitting the uplink signal to the second device according to the downlink signal.

According to the embodiments of the present disclosure, the second device (such as, the network device) may transmit the downlink signal to the first device (such as, the zero power consumption device), and the downlink signal carries the terminal identifier. The first device identifies that the terminal identifier is the self identifier of the first device, and transmits the uplink signal to the second device according to the downlink signal. The first device is the zero power consumption device that does not require a battery to supply power and may realize data transmission between the first device and second device through back scattering communication. Moreover, in a case where the first device identifies that the terminal identifier is the self identifier of the first device, different terminal devices may be distinguished. Therefore, not only can different devices be distinguished, but also data transmission requirements of zero power consumption can be met.

In a possible implementation, at least one of the following schemes (1) to (2) is included:
(1) the second device uses the downlink signal to supply power for the first device. For example, the first device is the zero power consumption device, and the second device is the network device, such as, a base station. A carrier signal transmitted by the base station is used as the downlink signal, the downlink signal itself may supply power for the zero power consumption device, and the downlink signal and a power supply signal are the same; or
(2) the second device transmits a power supply signal, and uses the power supply signal to supply power for the first device. For example, the first device is the zero power consumption device, and the second device is the network device, such as, a base station. The first device requires a signal other than the downlink signal as the power supply signal, and the power supply signal may be a carrier signal transmitted by another power supply nodes other than the base station in the network (a mobile phone, a relay node, or a CPE in the network, a deployed dedicated power supply node, or the like), and the downlink signal and the power supply signal are different.

In a possible implementation, the downlink signal may include two signals, and in a case where the downlink signal includes a first signal and a second signal, the first signal is used to carry the terminal identifier, and the second signal is used to carry downlink data or an indication of uplink data. For example, the first signal may be a trigger signal carrying the terminal identifier, and the second signal may be a data signal carrying the downlink data or the indication of uplink data, where the downlink data is data transmitted by the second device (the network device) to the first device (the zero power consumption device), and the indication of uplink data is used for the second device (the network device) to request uplink data to be received from the first device (the zero power consumption device).

In a possible implementation, the downlink signal may include one signal, and in a case where the downlink signal includes a first field and a second field, the first field is used to carry the terminal identifier, and the second field is used to carry downlink data or an indication of uplink data. Where the downlink data is data transmitted by the second device (the network device) to the first device (the zero power consumption device), and the indication of uplink data is used for the second device (the network device) to request uplink data to be received from the first device (the zero power consumption device).

In a possible implementation, the uplink signal includes an ACK or a NACK; where the ACK is used to describe that the downlink data is successfully received by the first device, and the NACK is used to describe that the downlink data is not successfully received by the first device.

In a possible implementation, the uplink signal includes uplink data, where the uplink data is used to describe data obtained by the first device according to the indication of uplink data.

FIG. 17 is a schematic data interaction diagram of a data transmission method 1700 according to an embodiment of the present disclosure. Optionally, the method may be applied to the system shown in FIG. 1, but is not limited thereto. The above first device is a zero power consumption device, the above second device is a network device, and the above downlink signal includes a first signal and a second signal, where the first signal is a trigger signal carrying the terminal identifier, and the second signal is a data signal carrying downlink data or an indication of uplink data. The downlink signal further includes a power supply signal transmitted through a deployed dedicated power supply node, that is, the power supply signal is a different signal from the trigger signal, and the method includes at least part of the following content.

S1710, the power supply node transmits a power supply signal.

S1720, the network device transmits the trigger signal, where the trigger signal carries the terminal identifier.

S1730, the network device transmits the data signal, where the data signal carries the downlink data or the indication of uplink data.

In some examples, the data signal is used for the network device to transmit the downlink data to the terminal device, or for the network device to request uplink data by transmitting the indication of uplink data to the terminal device.

S1740, the zero power consumption device receives the power supply signal and extracts power required in operation from the power supply signal.

S1750, in a case where the zero power consumption device identifies that the terminal identifier carried in the trigger signal is a self identifier of the zero power consumption device, the zero power consumption device receives the data signal.

In some examples, in the case where the zero power consumption device identifies that the terminal identifier carried in the trigger signal is the self identifier of the zero power consumption device, the downlink data transmitted by the network device is obtained from the data signal.

In some examples, in the case where the zero power consumption device identifies that the terminal identifier carried in the trigger signal is the self identifier of the zero power consumption device, the zero power consumption device obtains the indication of uplink data from the data signal, and prepares requested uplink data for the network device in response to the indication of uplink data.

S1760, the network device establishes back scattering communication with the zero power consumption device, and the network device receives an uplink signal transmitted by the zero power consumption device.

In some examples, the uplink signal is a reflected signal obtained according to the downlink signal, exemplarily, obtained according to the data signal. For example, in a case where the downlink data transmitted by the network device is obtained from the data signal, the uplink signal is determined according to whether the downlink data is successfully received, and the uplink signal includes: an ACK or a NACK. For example, in a case where the indication of uplink data is obtained from the data signal, the uplink signal is obtained in response to the indication of uplink data, and the uplink signal includes the uplink data (the uplink data is used to describe data obtained by the zero power consumption device according to the indication of uplink data).

The following is a detailed description of the above data transmission method provided by the embodiments of the present disclosure.

The zero power consumption device in the embodiments of the present disclosure may include a passive electronic tag, and the passive electronic tag may realize contactless automatic identification and transmission of identification information in the tag by using a radio coupling manner of a transmitting terminal and a receiving terminal (including inductive coupling of short-distance, electromagnetic coupling of long-distance, and the like). Exemplarily, the passive electronic tag using power obtained by an electromagnetic field generated in space to realize back scattering communication with zero power consumption, and when the passive electronic tag approaches a reader/writer, an antenna of the electronic tag is within a near-field range formed by radiation of an antenna of the reader/writer and generates an induced current through electromagnetic induction, and the induced current drives a chip circuit of the electronic tag. In a communication process, the chip circuit transmits identification information stored in the tag to the reader/writer through the antenna of the electronic tag. The reader/writer reads the identification information and decodes the identification information, thereby identifying information carried by the passive electronic tag. The reader/writer may be provided in any device that communicates with the zero power consumption device, for example, the reader/writer is provided in the network device, or the network device supports the read-write processing performed by the reader/writer, which are within the protection scope of the present disclosure.

Consider that if the downlink signal of the network device reaches multiple zero power consumption devices, which may trigger the multiple zero power consumption devices all to respond the downlink signal and transmit uplink signals (in back scattering communication, the uplink signals are reflected signals). The technical problems to be solved are: how to distinguish different zero power consumption devices to correctly receive the downlink data carried in the downlink signal transmitted by the network device in a transmission scenario of downlink data, and how to distinguish which uplink signal transmitted by different zero power consumption devices is requested by the network device itself through the indication of uplink data carried in the downlink signal to correctly receive the uplink signal transmitted by the zero power consumption device in a transmission scenario of uplink data.

According to following various examples of the embodiments of the present disclosure, it is distinguished by the terminal identifiers carried in the downlink signal, and in a back scattering scenario, the data transmission with zero power consumption is realized based on the zero power consumption device. In the following back scattering scenario, the uplink signal is a reflected signal, which will not be repeated in detail. In addition to being applicable to the data transmission corresponding to the zero power consumption device, the embodiments of the present disclosure are also applicable to other scenarios, such as initial access, paging.

### Example One

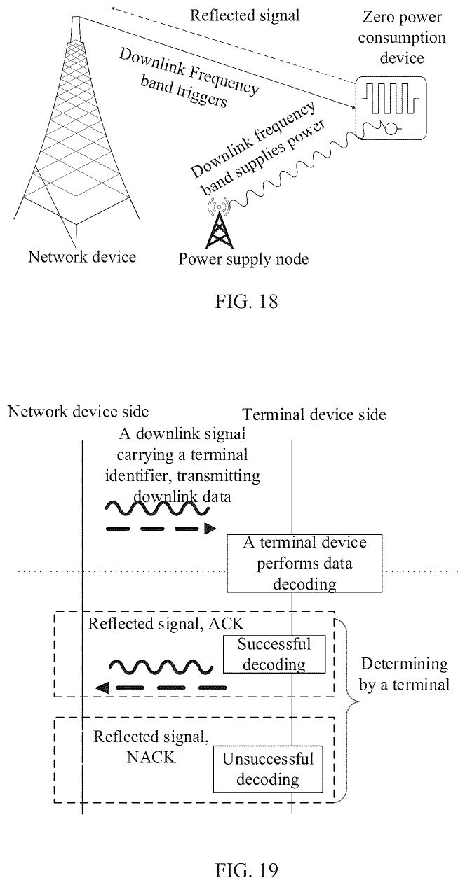

FIG. 18 is a schematic diagram of zero power consumption communication between a network device and a terminal device of an example of a data transmission method according to an embodiment of the present disclosure. As shown in FIG. 18, the terminal device is a zero power consumption device. Since the zero power consumption device is not equipped with a battery, it needs to obtain a power supply signal through a network device (such as, a base station) or other sources (such as, a dedicated deployed power supply node). In the example, the power supply signal is transmitted by the dedicated deployed power supply node to supply power required in operation of the zero power consumption device. The zero power consumption device receives a downlink signal and the power supply signal. Here, in a case where the downlink signal is two signals, the downlink signal includes a first signal (for example, a trigger signal carrying a terminal identifier) and a second signal (for example, a data signal carrying downlink data or an indication of uplink data), or in a case where the downlink signal is one signal, the downlink signal includes a first field (for example, trigger information carrying a terminal identifier) and a second field (for example, data information carrying downlink data or an indication of uplink data). After obtaining a reflected signal according to the downlink signal, the zero power consumption device transmits the reflected signal to the network device through back scattering.

It should be noted that if the power supply signal is transmitted by the dedicated deployed power supply node, the power supply signal and the downlink signal are different signals, and the two signals may not be transmitted in a same frequency band. If the power supply signal is transmitted through the network device (such as, the base station), the power supply signal and the downlink signal are the same signal, and the two signals may be transmitted in a same frequency band.

For the power supply signal, the network device may continuously or intermittently transmit the power supply signal in a certain frequency band, and the power supply signal is a continuous wave (CW), such as, a sine wave. If the power supply signal is continuously transmitted, the continuously transmitted power supply signal includes a continuous wave signal with constant amplitude. The zero power consumption device receives the power supply signal to perform power harvesting, and may perform functions such as signal reception, signal reflection, measurement after obtaining the power required in operation of the zero power consumption device.

### Example Two

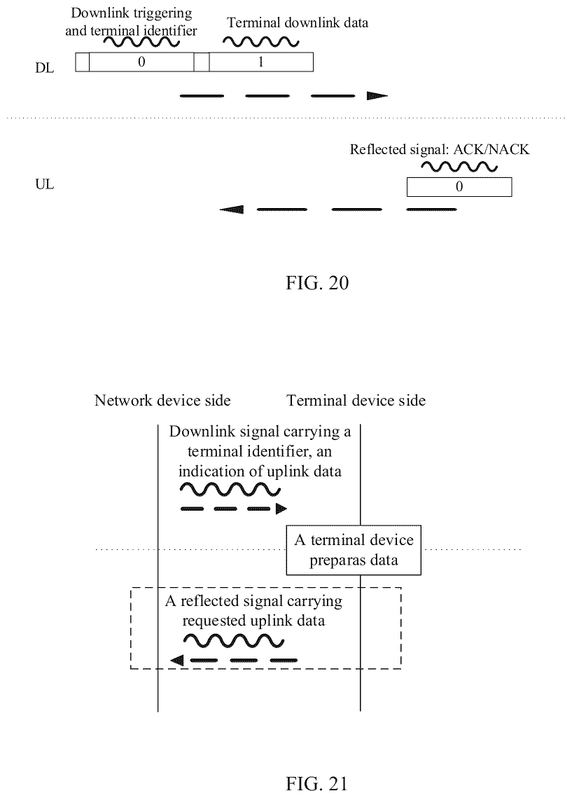

FIG. 19 is a schematic diagram of downlink data transmission between a network device and a terminal device of an example of a data transmission method according to an embodiment of the present disclosure. As shown in FIG. 19, the terminal device is a zero power consumption device, and a network device side transmits a downlink signal to the zero power consumption device. In a case where the downlink signal is one signal, as shown in FIG. 20, the downlink signal includes a first field (for example, trigger information carrying a terminal identifier) and a second field (for example, data information carrying downlink data). In the downlink signal, the terminal identifier is denoted as “0” and the downlink data is denoted as “1”. Feedback uplink data (such as, ACK/NACK) in a reflected signal may be denoted as “0”.

It should be noted that different forms of codes may be used to represent “1” and “0” of binary (in other words, different pulse signals are used to represent 0 and 1) when the zero power consumption device performs data transmission. A radio frequency identification system may use one of the following coding methods: reverse non-return-to-zero (NRZ) encoding, Manchester encoding, unipolar return-to-zero (Unipolar RZ) encoding, differential bi-phase (DBP) encoding, Miller encoding and differential encoding.

The downlink signal is used to supply power for the zero power consumption device, and the power required in operation of the zero power consumption device is extracted from the power supply signal. The zero power consumption device receives the downlink signal, and identifies that the terminal identifier carried by the first field in the downlink signal is the self identifier of the zero power consumption device, then the zero power consumption device receives the downlink data carried by the second field in the downlink signal, and determines the reflected signal according to whether the downlink data is successfully received. If the downlink data is successfully received, the reflected signal includes the ACK, the zero power consumption device establishes the back scattering communication with the network device, and transmits the reflected signal including the ACK; and if the downlink data is not successfully received, the reflected signal includes the NACK, the zero power consumption device establishes the back scattering communication with the network device, and transmits the reflected signal including the NACK.

FIG. 21 is a schematic diagram of uplink data transmission between a network device and a terminal device of an example of a data transmission method according to an embodiment of the present disclosure. As shown in FIG. 21, the terminal device is a zero power consumption device, and a network device side transmits a downlink signal to the zero power consumption device. In a case where the downlink signal is one signal, the downlink signal includes a first field (for example, trigger information carrying a terminal identifier) and a second field (for example, data information carrying an indication of uplink data). In the downlink signal, the terminal identifier and the indication of uplink data may be distinguished by using different identification information, for example, the terminal identifier is denoted as “O” and the indication of uplink data is denoted as “1”.

The downlink signal is used to supply power for the zero power consumption device, and the power required on operation of the zero power consumption device is extracted from the power supply signal. The zero power consumption device receives the downlink signal, and identifies that the terminal identifier carried by the first field in the downlink signal is the self identifier of the zero power consumption device, then the zero power consumption device receives the indication of uplink data carried by the second field in the downlink signal, and obtains a reflected signal according to the downlink signal in respond to the indication of uplink data, where the reflected signal includes uplink data requested by the network device to the zero power consumption device (the uplink data is used to describe data obtained by the zero power consumption device according to the indication of uplink data).

In the above examples, the downlink signal may further include a cell identifier, for example, in a case where the downlink signal is two signals, the first signal (such as, the trigger signal) carries the cell identifier, so that different cells are distinguished, thereby knowing which cell the zero power consumption device belongs to, and clearly determining which cell data should be transmitted to if data repetition occurs during data transmission.

In the above examples, which may be further included that the terminal identifier is carried in the reflected signal, and the terminal identifier may further be used as a preamble of the downlink signal. Optionally, which may be further included that the terminal identifier may not be included in the reflected signal. That is, carrying the terminal identifier in the reflected signal is optional and may be configured according to data transmission requirements.

In the above examples, both the downlink signal and the reflected signal may use a structure of time division to define different components of the corresponding signal, or may combine frequency division, code division and other manners to define the structure.

In the above examples, the reflected signal may be obtained by modulating the downlink signal. Optionally, the modulation schemes may include at least one of: amplitude modulation, phase modulation or frequency modulation. Here, in terms of the amplitude modulation, an amplitude of a carrier may vary with modulated signals, so as to obtain modulated signals with various amplitude. Exemplarily, the zero power consumption device may obtain the reflected signal by subcarrier modulation and then transmit the reflected signal to the network device. For example, the subcarrier modulation may modulate a signal on a carrier 1, or the modulation result of the carrier 1 may be modulated again to modulate the signal on another carrier 2 with higher frequency by using the modulation result.

It should be noted that the above examples may be combined with various possibilities in the above embodiments of the present disclosure, which will not be repeated here.

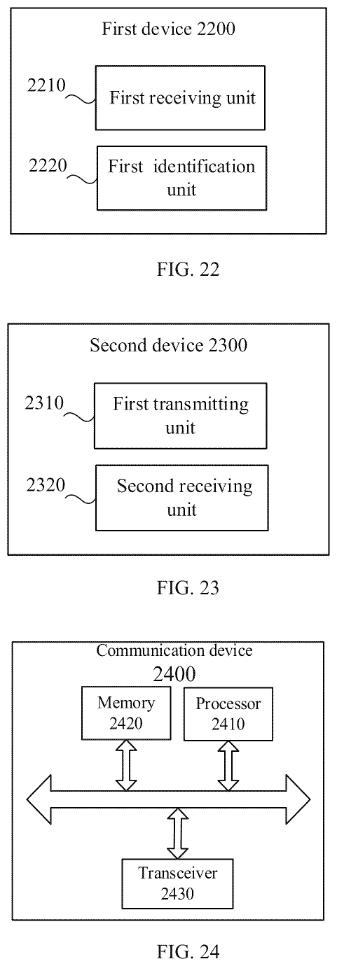

FIG. 22 is a schematic block diagram of a first device 2200 according to an embodiment of the present disclosure. The first device 2200 may include: a first receiving unit 2210, configured to receive a downlink signal transmitted by a second device, the downlink signal carrying a terminal identifier; and a first identification unit 2220, configured to identify that the terminal identifier is a self identifier of the first device, and transmit an uplink signal to the second device according to the downlink signal; where the first device is a zero power consumption device.

In a possible implementation, the downlink signal is used to supply power for the first device; or the first device further includes: a second receiving unit, configured to receive a power supply signal, and the power supply signal is used to supply power for the first device.

In a possible implementation, in a case where the downlink signal includes a first signal and a second signal, the first signal is used to carry the terminal identifier, and the second signal is used to carry downlink data or an indication of uplink data.

In a possible implementation, in a case where the downlink signal includes a first field and a second field, the first field is used to carry the terminal identifier, and the second field is used to carry downlink data or an indication of uplink data.

In a possible implementation, the first identification unit is configured to: obtain the terminal identifier from the first signal received; identify that the terminal identifier is the self identifier of the first device; receive the second signal; determine the uplink signal according to whether the downlink data in the second signal is successfully received; and transmit the uplink signal to the second device.

In a possible implementation, the first identification unit is configured to: determine, in a case where the downlink data is successfully received, that the uplink signal is an ACK; or determine, in a case where the downlink data is not successfully received, that the uplink signal is a NACK.

In a possible implementation, there is a time interval between the first signal and the second signal.

In a possible implementation, the first identification unit is configured to: perform demodulation on the downlink signal to obtain the terminal identifier; identify that the terminal identifier is the self identifier of the first device; receive the downlink data; determine the uplink signal according to whether the downlink data is successfully received; and transmit the uplink signal to the second device.

In a possible implementation, the first identification unit is configured to: determine, in a case where the downlink data is successfully received, that the uplink signal is an ACK; or determine, in a case where the downlink data is not successfully received, that the uplink signal is a NACK.

In a possible implementation, the first identification unit is configured to: obtain the terminal identifier from the downlink signal; perform descrambling of a CRC check according to the terminal identifier; identify that the terminal identifier is the self identifier of the first device in a case of successful descrambling; receive the downlink data; determine the uplink signal according to whether the downlink data is successfully received; and transmit the uplink signal to the second device.

In a possible implementation, the first identification unit is configured to: determine, in a case where the downlink data is successfully received, that the uplink signal is an ACK; or determine, in a case where the downlink data is not successfully received, that the uplink signal is a NACK.

In a possible implementation, the first device further includes: a marking unit, configured to respectively mark the ACK and the NACK by means of different sequences.

In a possible implementation, the first identification unit is configured to: obtain the terminal identifier from the first signal received; identify that the terminal identifier is the self identifier of the first device; receive the second signal; and transmit the uplink signal to the second device according to the indication of uplink data in the second signal; where the uplink signal includes the uplink data.

In a possible implementation, there is a time interval between the first signal and the second signal.

In a possible implementation, the first identification unit is configured to: perform demodulation on the downlink signal to obtain the terminal identifier; identify that the terminal identifier is the self identifier of the first device; receive the indication of uplink data; and transmit the uplink signal to the second device according to the indication of uplink data; where the uplink signal includes the uplink data.

In a possible implementation, the first identification unit is configured to: obtain the terminal identifier from the downlink signal; perform descrambling of a CRC check according to the terminal identifier; identify that the terminal identifier is the self identifier of the first device in a case of successful descrambling; receive the indication of uplink data; and transmit the uplink signal to the second device according to the indication of uplink data; where the uplink signal includes the uplink data.

In a possible implementation, the first device further includes: a scrambling unit configured to perform scrambling on the uplink signal by a CRC check manner.

In a possible implementation, the terminal identifier is an identifier registered when the first device initially accesses a network.

The first device 2200 in the embodiments of the present disclosure may be a zero power consumption device, which may realize corresponding functions of the first device in the above method embodiments. Processes, functions, implementations and beneficial effects corresponding to each module (submodule, unit, component, or the like) of the first device 2200 may be referred to the corresponding description in the above method embodiments, which will not be repeated here. It should be noted that the functions described with respect to each module (submodule, unit, component, or the like) in the first device 2200 in the embodiments of the present disclosure may be implemented by different modules (submodules, units, components, or the like), or may be implemented by the same module (submodule, unit, component, or the like).

FIG. 23 is a schematic block diagram of a second device 2300 according to an embodiment of the present disclosure. The second device 2300 may include: a first transmitting unit 2310, configured to transmit a downlink signal to a first device, the downlink signal carrying a terminal identifier; and a second receiving unit 2320, configured to receive an uplink signal; where the uplink signal is a signal obtained according to the downlink signal in a case where the first device performs identification based on the terminal identifier, and the first device is a zero power consumption device.

In a possible implementation, the first transmitting unit is configured to: use the downlink signal to supply power for the first device; or transmit a power supply signal, and use the power supply signal to supply power for the first device.

In a possible implementation, in a case where the downlink signal includes a first signal and a second signal, the first signal is used to carry the terminal identifier, and the second signal is used to carry downlink data or an indication of uplink data.

In a possible implementation, in a case where the downlink signal includes a first field and a second field, the first field is used to carry the terminal identifier, and the second field is used to carry downlink data or an indication of uplink data.

In a possible implementation, the uplink signal includes an ACK or a NACK; where the ACK is used to describe that the downlink data is successfully received by the first device, and the NACK is used to describe that the downlink data is not successfully received by the first device.

In a possible implementation, the uplink signal includes uplink data, where the uplink data is used to describe data obtained by the first device according to the indication of uplink data.

In a possible implementation, the terminal identifier is an identifier registered when the first device initially accessed a network.

The second device 2300 in the embodiments of the present disclosure may be a network device, which may realize corresponding functions of the second device in the above method embodiments. Processes, functions, implementations and beneficial effects corresponding to each module (submodule, unit, component, or the like) of the second device 2300 may be referred to the corresponding description in the above method embodiments, which will not be repeated here. It should be noted that the functions described with respect to each module (submodule, unit, component, or the like) in the second device 2300 in the embodiments of the present disclosure may be implemented by different modules (submodules, units, components, or the like), or may be implemented by the same module (submodule, unit, component, or the like).

FIG. 24 is a schematic structural diagram of a communication device 2400 according to the embodiments of the present disclosure. The communication device 2400 includes a processor 2410, and processor 2410 may call and run a computer program from a memory to cause the communication device 2400 to implement the methods in the embodiments of the present disclosure.

Optionally, the communication device 2400 may also include a memory 2420. Here, the processor 2410 may call and run a computer program from the memory 2420 to cause the communication device 2400 to implement the methods in the embodiments of the present disclosure.

The memory 2420 may be a separate device independent from the processor 2410 or may also be integrated into the processor 2410.

Optionally, the communication device 2400 may also include a transceiver 2430, and the processor 2410 may control the transceiver 2430 to communicate with other devices, and exemplarily, to transmit information or data to other devices, or receive information or data transmitted by the other devices.

The transceiver 2430 may include a transmitter and a receiver. The transceiver 2430 may further include an antenna. A quantity of the antenna may be one or more.

Optionally, the communication device 2400 may be the first device in the embodiments of the present disclosure, and the communication device 2400 may implement the corresponding processes implemented by the first device in various methods of the embodiments of the present disclosure, which will not be repeated here for the sake of brevity.

Optionally, the communication device 2400 may be the second device in the embodiments of the present disclosure, and the communication device 2400 may implement the corresponding processes implemented by the second device in various methods of the embodiments of the present disclosure, which will not be repeated here for the sake of brevity.

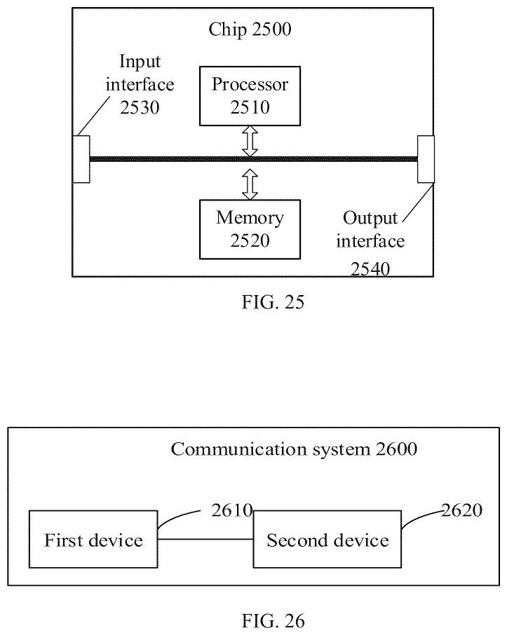

FIG. 25 is a schematic block diagram of a chip 2500 according to the embodiments of the present disclosure. The chip 2500 includes a processor 2510, and the processor 2510 may call and run a computer program from a memory to implement the methods in the embodiments of the present disclosure.

Optionally, chip 2500 may also include a memory 2520. The processor 2510 may call and run a computer program from a memory 2520 to implement the methods performed by the first device or the second device in the embodiments of the present disclosure.

The memory 2520 may be a separate device independent from the processor 2510, or may also be integrated into the processor 2510.

Optionally, the chip 2500 may further include an input interface 2530. The processor 2510 may control the input interface 2530 to communicate with other devices or chips, exemplarily, may acquire information or data transmitted by other devices or chips.

Optionally, the chip 2500 may further include an output interface 2540. Here, the processor 2510 may control the output interface 2540 to communicate with other devices or chips, and exemplarily, to input information or data to other devices or chips.

Optionally, the chip may be applied to the first device in the embodiments of the present disclosure, and the chip may implement the corresponding processes implemented by the first device in the various methods of the embodiments of the present disclosure, which will not be repeated here for the sake of brevity.

Optionally, the chip may be applied to the second device in the embodiments of the present disclosure, and the chip may implement the corresponding processes implemented by the second device in the various methods of the embodiments of the present disclosure, which will not be repeated here for the sake of brevity.

The chips applied to the first device and the second device may be a same chip or different chips.

It should be understood that, the chip mentioned in the embodiments of the present disclosure may also be referred to as a system-level chip, a system chip, a chip system or a system-on-chip, or the like.

The processor mentioned above may be a general-purpose processor, a digital signal processor (DSPS), a field programmable gate array (FPGA), an application specific integrated circuit (ASIC), other programmable logic devices, transistor logic devices or discrete hardware components, or the like. Here, the general-purpose processor mentioned above may be a microprocessor or may also be any conventional processor, or the like.

The memory mentioned above may be a volatile (transitory) memory or a non-volatile (non-transitory) memory, or may include both the volatile memory and the non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or flash memory. The volatile memory may be a random access memory (RAM).

It should be understood that the above memory is exemplary but not limited illustration. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct Rambus random access memory (Direct Rambus RAM, DR RAM), or the like. That is, the memory in the embodiments of the present disclosure is intended to include, but not limited to, these and any other suitable types of memories.

FIG. 26 is a schematic block diagram of a communication system 2600 according to the embodiments of the present disclosure. The communication system 2600 includes a first device 2610 and a second device 2620. Here, the first device 2610 may be a zero power consumption device and include: a first receiving unit configured to receive a downlink signal transmitted by a second device, the downlink signal carrying a terminal identifier; and a first identification unit configured to identify that the terminal identifier is a self identifier of the first device and transmit an uplink signal to the second device according to the downlink signal; where the first device is the zero power consumption device. The second device 2620 may be a network device and include: a first transmitting unit configured to transmit the downlink signal to the first device, the downlink signal carrying the terminal identifier; and a second receiving unit configured to receive the uplink signal; where the uplink signal is a signal obtained according to the downlink signal in a case where the first device performs identification based on the terminal identifier, and the first device is a zero power consumption device, which will not be repeated here for the sake of brevity.

The above embodiments may be implemented in whole or in part by software, hardware, firmware, or any combination thereof. When the above embodiments are implemented by using software, they may be implemented in a form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a computer readable storage medium or transmitted from one computer readable storage medium to another computer readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave) means. The computer readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)), a semiconductor medium (e.g., a solid state disk (SSD)), or the like.

It should be understood that, in the various embodiments of the present disclosure, a size of serial numbers of the above processes does not imply an order of execution, and the execution order of the respective processes should be determined by their function and internal logic, but should not constitute any limitation on the implementation processes of the embodiments of the present disclosure.

Those skilled in the art may clearly understand that, for the convenience and brevity of the description, the specific working processes of the systems, apparatus and units described above may refer to the corresponding processes in the above method embodiments, which will not be repeated here.

The foregoing descriptions are merely specific implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. A data transmission method, applied to a first device and comprising:
receiving, by the first device, a downlink signal transmitted by a second device, the downlink signal carrying a terminal identifier;
identifying, by the first device, that the terminal identifier is a self identifier of the first device; and
transmitting, by the first device, an uplink signal to the second device according to the downlink signal;
wherein the first device is a zero power consumption device.

2. The method according to claim 1, wherein the downlink signal is used to supply power for the first device; or
the method further comprises:
receiving, by the first device, a power supply signal, the power supply signal being used to supply power for the first device.

3. The method according to claim 1, wherein in a case where the downlink signal comprises a first signal and a second signal, the first signal is used to carry the terminal identifier, and the second signal is used to carry downlink data or an indication of uplink data; and
wherein there is a time interval between the first signal and the second signal.

4. The method according to claim 1, wherein in a case where the downlink signal comprises a first field and a second field, the first field is used to carry the terminal identifier, and the second field is used to carry downlink data or an indication of uplink data.

5. The method according to claim 3, wherein identifying, by the first device, that the terminal identifier is the self identifier of the first device, and transmitting, by the first device, the uplink signal to the second device according to the downlink signal comprises:
obtaining, by the first device, the terminal identifier from the first signal received;
identifying, by the first device, that the terminal identifier is the self identifier of the first device, and receiving, by the first device, the second signal;
determining, by the first device, the uplink signal according to whether the downlink data in the second signal is successfully received; and
transmitting, by the first device, the uplink signal to the second device.

6. The method according to claim 5, wherein determining, by the first device, the uplink signal according to whether the downlink data in the second signal is successfully received comprises:
determining, in a case where the downlink data is successfully received, that the uplink signal is an acknowledgement (ACK); or
determining, in a case where the downlink data is not successfully received, that the uplink signal is a negative acknowledgement (NACK);
wherein the method further comprises:
respectively marking the ACK and the NACK by means of different sequences.

7. The method according to claim 4, wherein identifying, by the first device, that the terminal identifier is the self identifier of the first device, and transmitting, by the first device, the uplink signal to the second device according to the downlink signal comprises:
performing, by the first device, demodulating on the downlink signal to obtain the terminal identifier;
identifying, by the first device, that the terminal identifier is the self identifier of the first device, and receiving, by the first device, the downlink data;
determining, by the first device, the uplink signal according to whether the downlink data is successfully received; and
transmitting, by the first device, the uplink signal to the second device.

8. The method according to claim 7, wherein determining, by the first device, the uplink signal according to whether the downlink data is successfully received comprises:
determining, in a case where the downlink data is successfully received, that the uplink signal is an acknowledgement (ACK); or
determining, in a case where the downlink data is not successfully received, that the uplink signal is a negative acknowledgement (NACK);
wherein the method further comprises:
respectively marking the ACK and the NACK by means of different sequences.

9. The method according to claim 4, wherein identifying, by the first device, that the terminal identifier is the self identifier of the first device, and transmitting, by the first device, the uplink signal to the second device according to the downlink signal comprises:
obtaining, by the first device, the terminal identifier from the downlink signal;
performing, by the first device, descrambling of a cyclic redundancy check (CRC) check according to the terminal identifier, identifying, by the first device, that the terminal identifier is the self identifier of the first device in a case of successful descrambling, and receiving, by the first device, the downlink data;
determining, by the first device, the uplink signal according to whether the downlink data is successfully received; and
transmitting, by the first device, the uplink signal to the second device.

10. The method according to claim 9, wherein determining, by the first device, the uplink signal according to whether the downlink data is successfully received comprises:
determining, in a case where the downlink data is successfully received, that the uplink signal is an acknowledgement (ACK); or
determining, in a case where the downlink data is not successfully received, that the uplink signal is a negative acknowledgement (NACK);
wherein the method further comprises:
respectively marking the ACK and the NACK by means of different sequences.

11. The method according to claim 3, wherein identifying, by the first device, that the terminal identifier is the self identifier of the first device, and transmitting, by the first device, the uplink signal to the second device according to the downlink signal comprises:
obtaining, by the first device, the terminal identifier from the first signal received;
identifying, by the first device, that the terminal identifier is the self identifier of the first device, and receiving, by the first device, the second signal; and
transmitting, by the first device, the uplink signal to the second device according to the indication of uplink data in the second signal; wherein the uplink signal comprises the uplink data.

12. A first device, comprising: a processor and a memory, wherein the memory is configured to store a computer program, and the processer is configured to call and run the computer program stored in the memory, to cause the first device to perform the steps of:
receiving a downlink signal transmitted by a second device, the downlink signal carrying a terminal identifier;
identifying that the terminal identifier is a self identifier of the first device; and
transmitting an uplink signal to the second device according to the downlink signal;
wherein the first device is a zero power consumption device.

13. The first device according to claim 12, wherein in a case where the downlink signal comprises a first signal and a second signal, the first signal is used to carry the terminal identifier, and the second signal is used to carry downlink data or an indication of uplink data; and
wherein there is a time interval between the first signal and the second signal.

14. The first device according to claim 12, wherein in a case where the downlink signal comprises a first field and a second field, the first field is used to carry the terminal identifier, and the second field is used to carry downlink data or an indication of uplink data.

15. The first device according to claim 13, wherein the processer is configured to call and run the computer program stored in the memory, to cause the first device further to perform the steps of:
obtaining the terminal identifier from the first signal received;
identifying that the terminal identifier is the self identifier of the first device, and receiving the second signal;
determining the uplink signal according to whether the downlink data in the second signal is successfully received; and
transmitting the uplink signal to the second device;
or
to cause the first device further to perform the steps of:
obtaining the terminal identifier from the first signal received;
identifying that the terminal identifier is the self identifier of the first device, and receiving the second signal; and
transmitting the uplink signal to the second device according to the indication of uplink data in the second signal; wherein the uplink signal comprises the uplink data.

16. The first device according to claim 14, wherein the processer is configured to call and run the computer program stored in the memory, to cause the first device further to perform the steps of:
performing demodulating on the downlink signal to obtain the terminal identifier;
identifying that the terminal identifier is the self identifier of the first device, and receiving the downlink data;
determining the uplink signal according to whether the downlink data is successfully received; and
transmitting the uplink signal to the second device;
or
to cause the first device further to perform the steps of:
obtaining the terminal identifier from the downlink signal;
performing descrambling of a cyclic redundancy check (CRC) check according to the terminal identifier, identifying that the terminal identifier is the self identifier of the first device in a case of successful descrambling, and receiving the downlink data;
determining the uplink signal according to whether the downlink data is successfully received; and
transmitting the uplink signal to the second device.

17. A second device, comprising: a processor and a memory, wherein the memory is configured to store a computer program, and the processer is configured to call and run the computer program stored in the memory, to cause the second device to perform the steps of:
transmitting a downlink signal to a first device, the downlink signal carrying a terminal identifier; and
receiving an uplink signal;
wherein the uplink signal is a signal obtained according to the downlink signal in a case where the first device performs identification based on the terminal identifier, and the first device is a zero power consumption device.

18. The second device according to claim 17, wherein the processer is configured to call and run the computer program stored in the memory, to cause the second device further to perform the steps of:
using the downlink signal to supply power for the first device; or
transmitting a power supply signal, and using the power supply signal to supply power for the first device.

19. The second device according to claim 17, wherein in a case where the downlink signal comprises a first signal and a second signal, the first signal is used to carry the terminal identifier, and the second signal is used to carry downlink data or an indication of uplink data; or
in a case where the downlink signal comprises a first field and a second field, the first field is used to carry the terminal identifier, and the second field is used to carry downlink data or an indication of uplink data.

20. The second device according to claim 19, wherein the uplink signal comprises an acknowledgement (ACK) or a negative acknowledgement (NACK); wherein the ACK is used to describe that the downlink data is successfully received by the first device, and the NACK is used to describe that the downlink data is not successfully received by the first device; and
the uplink signal comprises uplink data, wherein the uplink data is used to describe data obtained by the first device according to the indication of uplink data.
